(19) United States
(12) Patent Application Publication
(10) Pub. No.: US 2023/0418901 A1
(43) Pub. Date: Dec. 28, 2023

(54) Non-Programming Platform for Matrix and Vector Operations in Linear Algebra

(71) Applicant: Deping Li, Pennington, NJ (US)

(72) Inventor: Deping Li, Pennington, NJ (US)

(21) Appl. No.: 17/846,727

(22) Filed: Jun. 22, 2022

(51) Int. Cl. G06F 17/16

(52) U.S. Cl. CPC G06F 17/16

(57) ABSTRACT

A non-programming platform consisting of modules (functions) is created for matrix and vector operations in linear algebra. Each module appears to be a typical math function and can carry out a class of distinct matrix and vector operations. By taking a short line of user input at interface, each module can be applied separately or along with other modules and math functions as well as their combinations and compositions for various matrix operations. For an intended operation, users only need to write a short line of self-explaining input, which is required to write in math language, in a logic order, and appear to be human readable math expressions and functions. This platform enables users to have the common functionalities in most matrix calculators and computer algebra systems, so they can focus on learning essential concepts and relations in linear algebra instead of on programming commands and syntax.

### BACKGROUND OF THE INVENTION

Platforms for operating with matrices and vectors are already established in many computer algebra systems (CAS) that usually require distinct programming environments and languages. A few examples of these systems are Sympy, Numpy, Mathematica, MatLab, Maple, Maxima, and Wolframe.

To use these systems for matrix and vector operations, users should have some basic programming skills or prior knowledge of computer languages and commands. For example, users of Sympy and Numpy use Python to write some commands for matrix operations and manipulations in a programming environment like Jupyter. Some general purpose systems such as Mathematica, Maple, Maxima, MatLab, and Wolframe have their own syntax and commands for various matrix and vector operations.

Other matrix calculators that appear in some web applications (e.g., Symbolab, Matrixcalc, and Desmos) have a panel or a number of buttons at interface for inputting the dimensions, operators, functions, and entries of matrices in a fixed format. Although syntax and commands are not required, users have limited choices for matrix functions and operations. A major drawback of those web applications is that the combination and composition of matrix operations are usually not allowed, which greatly restrict users from combining and composing two or more functions for complicated matrix operations, and thus verifying some important properties and relations that rely on matrix combinations and compositions becomes difficult or even impossible.

This invention does not require users to have prior skill or knowledge of any computer language (e.g., Python and C++), nor does it require any particular programming environment and input panel and buttons arranged in certain format. Using the platform of this inversion at interface, users only need to write a short line of input for their intended matrices operations, as they write homework exercises.

### BRIEF SUMMARY OF THE INVENTION

A non-programming platform consisting of modules (functions) provides an effective tool for operating with matrices and vectors. By taking a user input at interface, each module can be applied separately or along with other modules and functions from simple addition, subtraction, multiplication, and finding echelon form, projection, inverse, determinant, trace, norm, and rank to complicated operations (e.g., computing eigenvalues and eigenvectors, orthogonalization and diagonalization) as well as their combinations and compositions. For an intended operation, users need to write a short line of self-explaining input, which include three-character module names, and some necessary elements such as functions, variables, numbers, choices of options, and other related parameters. This platform enables users to have the common functionalities in most computer algebra systems, simplify the process for matrix operations, so they can focus on learning essential concepts and relations in linear algebra instead of on programming commands and syntax.

The modules are implemented in a web application, so users can use them for their interested operations at an on-line interface via computers, cell phones, tablets, or any other similar devices that have an access to the Internet. These modules can also be installed into stand-alone personal computers, workstations, servers, or other appropriate devices.

### DETAILED DESCRIPTION OF THE INVENTION

A non-programming platform consisting of modules (functions) is created for operating with matrices and vectors. Each module, which is denoted by three characters and appears to be typical math functions (e.g., “sin”, “log”, “exp”), can carry out a class of distinct matrix operations in linear algebra. It can be applied separately for its associated operations, and can also combine and compose with other modules and functions to form more complex matrix operations. Thus, the platform enables users to write flexible matrix operations at interface, and accomplish complicated matrix operations with just a single line of input.

Applying a module to a particular matrix operation is just as users calling a standard math function, but it involves more necessary parameters or arguments necessary. For example, “mat; det(A); A; [(1,2,3),(5,4,6),(2,5,4)]” calculates the determinant (=21) of a matrix, where “mat” stands for matrix operation, “det(A)” for the determinant function, and “A; [(1,2,3),(4,5,6),(7,8,9)]” gives entries of the matrix A. This simple way of writing an array of necessary elements at interface, rather than writing extra command lines and syntax in a programming environment, simplifies the process for computing matrix operations. These kinds of short inputs, though slightly differ from expressions in math textbooks, are self-explained because all necessary elements are required to write in math language, in a logic order, and appear as human readable math functions and expressions.

In general, user inputs start with “mat” for matrix operations, followed by matrix functions or operations, and then the entries of each matrix. For the operations with a single matrix, “mat; f(A); A; entryArray” returns the result of f(A). For the operations with two matrices, “mat; f(A,B); A; entryA; B; entryB” yields the result of f(A,B). Users can continue this pattern in a similar way for a different number of matrices and operations as well as their combinations and compositions. The elements that represent the module names, functions, variables, numbers, keywords, choices of values, and other related parameters constitute the basic use inputs. The following sections describe in detail on how to use these modules for different classes of matrix and vector operations to solve problems in linear algebra by writing a short input at interface.

(1) Matrix Operations and Manipulations

All matrix operations must start with the module name “mat” to distinguish it from other modules (calculus) and operations. A typical pattern for any operation on a matrix or vector A is “mat; f(A); A; matAarray”, where “f(A)” represents a particular matrix function or operation, and the pair “A; matArray” defines an m×n matrix A with entries as [(a₁₁, a₁₂, . . . , a₁ₙ), (a₂₁, a₂₂, . . . , a₂ₙ) . . . , (aₘ₁, aₘ₂, . . . , aₘₙ)], where each entry can be a number, variable, or expression.

The pattern “mat; A; A; matAarray” for f(A)=A just displays the matrix entries, “mat; elf(A); A; matAarray” reduces A to an echelon form, and “mat; A*tsp(A); A; matArray” calculates the matrix product AA^{T}. This pattern can be extended to two or more matrices along with more complicated operations such as “mat; f(A, B); A; matAarray, B; matBarray”, “mat; f(A, B, C); A; matAarray, B; matBarray; C; matCarray” and so on. For example, “mat; inv(P)*A*P; A; matAarray; P; matParray” calculates the product of three matrices P⁻¹AP.

I. Row Vectors, Column Vectors, and Matrices

For a vector v=(a, b, c), “mat; v; v; [(a, b, c)]” displays v as a 1×3 row vector, and “mat; v; v; [a, b, c]” or “mat; v; v; (a, b, c)” displays v as a 3×1 column vector. The elements of a row or column are separated by a comma (,) and included in a parenthesis. A row or column vector is a special form of a matrix. In particular, “mat; A; A; [c]” returns a 1×1 matrix with the only entry c.

A matrix consists of multiple rows or columns and can be entered in a similar fashion. A 2×2 matrix can be displayed by “mat; A; A; [(a, b), (c, d)]” with the first row “(a, b)” and the second row “(c, d)”. Similarly, “mat; A; A; [(a, b, c), (x, y, z), (1, 2, 3)]” shows a 3×3 matrix with three rows in the order within the square bracket. The elements of each row of the matrix are included in a parenthesis and are separated from each other by a comma (,).

It is more convenient to enter a matrix row by row in order. Use the transpose function “tsp(A)” if the columns of A are of concern. For example, “mat; tsp(A); A; [(a, b, c), (x, y, z), (1, 2, 3)]” shows a 3×3 matrix with the first column (a, b, c)′, second (x, y, z)′, and third (1, 2, 3)′. Or enter the matrix directly by “mat;A;A;[(a,x,1),(b,y,2),(c,z,3)]”.

II. Complex Matrices and Special Symbols

The entries of a complex matrix involve complex numbers of the form a+bi. Use “I” for the imaginary number i, for example, “mat;A;A;[1+2*I,2−3*I,−4*I]” displays a column vector (1+2i, 2−3i, −4i)^{T}. In addition, if the entries of a matrix involve the irrational numbers e, π, use “E” for “e” and “pi” for π.

$$\begin{matrix}Q : mat ; a ; a ; [ ( 2 , 2 / 3 , - {5}^{⋀} ( 1 / 2 ) , pi , {c}^{⋀} 2 ) ] \\ A : = [ \begin{matrix}2 & \frac{2}{3} & - \sqrt{5} & π & {c}^{2}\end{matrix} ]\end{matrix}$$

$$\begin{matrix}Q : mat ; b ; b ; [ 5 , - 3 , 7 ] \\ A : = [ \begin{matrix}5 \\ - 3 \\ 7\end{matrix} ]\end{matrix}$$

$$\begin{matrix}Q : mat ; A ; A ; [ ( 2 , 3 , 5 , 2 + {3}^{*} I ) , ( 0 , 1 / {2}^{⋀} ( 1 / 2 ) , - 1 , 0 ) , \\ ( 2 , - 1 , 3 , - {5}^{*} I ) ] \\ A : = [ \begin{matrix}2 & 3 & 5 & 2 + 3 i \\ 0 & \frac{\sqrt{2}}{2} & - 1 & 0 \\ 2 & - 1 & 3 & - 5 i\end{matrix} ]\end{matrix}$$

III. Echelon Form and Reduced Row Echelon Form

The function “elf(A)” reduces a matrix A to echelon form, and the function “rref(A)” reduces A to reduced row echelon form.

$$\begin{matrix}Q : mat ; rref ( A ) ; A ; [ 1 , 3 , - 2 , 2 , 0 , 0 ) , ( 2 , 6 , - 5 , - 2 , 4 , - 3 , - 1 ) , \\ ( 0 , 0 , 5 , 10 , 0 , 15 , 5 ) , ( 2 , 6 , 0 , 8 , 4 , 18 , 6 ) ] \\ A : rref = [ \begin{matrix}1 & 2 & 0 & 4 & 2 & 0 & 0 \\ 0 & 0 & 1 & 2 & 0 & 0 & 0 \\ 0 & 0 & 0 & 0 & 0 & 1 & \frac{1}{3} \\ 0 & 0 & 0 & 0 & 0 & 0 & 0\end{matrix} ]\end{matrix}$$

$$\begin{matrix}Q : mat ; rref ( A ) ; A ; [ ( 1 , 2 , 2 ) , ( 2 , 5 , 7 ) , ( 3 , 6 , 8 ) ] \\ A : rref = [ \begin{matrix}1 & 0 & 0 \\ 0 & 1 & 0 \\ 0 & 0 & 1\end{matrix} ]\end{matrix}$$

$$\begin{matrix}Q : mat ; elf ( A ) ; A ; [ ( 1 , 2 , 1 , 3 , 3 ) , ( 2 , 4 , 0 , 4 , 4 ) , ( 1 , 2 , 3 , 5 , 5 ) , \\ ( 2 , 4 , 0 , 4 , 7 ) ] \\ A : elf = [ \begin{matrix}1 & 2 & 1 & 3 & 3 \\ 0 & 0 & - 2 & - 2 & - 2 \\ 0 & 0 & 0 & 0 & 6 \\ 0 & 0 & 0 & 0 & 0\end{matrix} ]\end{matrix}$$

IV. Augmented Matrices

Matrices with compatible dimensions can be merged to form a new matrix. The augmented matrix of the linear system Ax=b can be obtained by “mrg(A, b)” that merges A and b by row, where A is the coefficient matrix and b is the constant vector (column). With an option, the function “mrg(A,B,1)” places matrix B under A and forms a new matrix by column.

$$\begin{matrix}Q : mat ; mrg ( A , b ) ; A ; [ ( 2 , 3 , - 2 ) , ( 1 , 0 , 5 ) , ( 3 , 1 , - 2 ) ] ; b ; [ a , b , c ] \\ A : = [ \begin{matrix}2 & 3 & - 2 & a \\ 1 & 0 & 5 & b \\ 3 & 1 & - 2 & c\end{matrix} ]\end{matrix}$$

$$\begin{matrix}Q : mat ; mrg ( A , B ) ; A ; [ ( 1 , 2 , 3 ) , ( 1 , 0 , 4 ) ] ; B ; \{ ( a , b ) , ( c , d ) ] \\ A : = [ \begin{matrix}1 & 2 & 3 & a & b \\ 1 & 0 & 4 & c & d\end{matrix} ]\end{matrix}$$

$$\begin{matrix}Q : mat ; mrg ( A , B , 1 ) ; A ; [ ( 2 , 1 , 3 ) , ( 5 , 1 , 0 ] ; B ; [ ( a , b , c ) , ( x , y , z ) ] \\ A : = [ \begin{matrix}2 & 1 & 3 \\ 5 & 1 & 0 \\ a & b & c \\ x & y & z\end{matrix} ]\end{matrix}$$

V. Rotation Matrices

For a given angle θ measured in radian, the functions “rtm(θ, 1)”, “rtm(θ, 2)”, and “rtm(θ, 3)” returns the rotation matrices Rₓ, R_{y}, and R_{z} that correspond to the rotation about the x-axis, y-axis, and z-axis, respectively. They are 3×3 orthogonal matrices with norm equal to 1, which can be verified by the fact AA^{T}=I, for instance, “mat; A*tsp(A); A;rtm(1)” yields a 3×3 identity matrix and “mat;nom(A);A;rtm(1.5)” returns 1.

$$\begin{matrix}Q : mat ; rtm ( pi / 4 , 1 ) \\ A : {R}_{x} = [ \begin{matrix}1 & 0 & 0 \\ 0 & \frac{\sqrt{2}}{2} & \frac{\sqrt{2}}{2} \\ 0 & - \frac{\sqrt{2}}{2} & \frac{\sqrt{2}}{2}\end{matrix} ]\end{matrix}$$

$$\begin{matrix}Q : mat ; rtm ( pi / 2 , 2 ) \\ A : {R}_{y} = [ \begin{matrix}0 & 0 & - 1 \\ 0 & 1 & 0 \\ 1 & 0 & 0\end{matrix} ]\end{matrix}$$

$$\begin{matrix}Q : mat ; rtm ( pi / 3 , 3 ) \\ A : {R}_{z} = [ \begin{matrix}\frac{1}{2} & \frac{\sqrt{3}}{2} & 0 \\ - \frac{\sqrt{3}}{2} & \frac{1}{2} & 0 \\ 0 & 0 & 1\end{matrix} ]\end{matrix}$$

VI. Jacobian Matrices

In vector calculus, the Jacobian matrix is the first partial derivatives of a vector-valued function f(x, y, z) taken with respect to u, v, and w (for instance). The array “mat; jcb(a, b); a; [x(u,v,w), y(u,v,w), z(u,v,w)]; b; [u, v, w]” calculates the Jacobian matrix of f(x, y, z)=x(u, v, w)i+y(u, v, w)j+z(u, v, w)k”, where “a” is the components vector “<x(u, v, w), y(u, v, w), z(u, v, w)>” of f(x, y, z), and “b” is a vector “<u, v, w>” consisting of the (symbolic) variables u, v, and w. The function “det(jcb(a,b))” calculates the determinant of the Jacobian matrix jcb(a,b).

$$Q : mat ; jcb ( a , b ) ; a ; [ u - 2 * v , 3 * u + v ] ; b ; [ u , v ]$$

$$A := [ \begin{matrix}1 & - 2 \\ 3 & 1\end{matrix} ]$$

$$Q : mat ; jcb ( a , b ) ; a ; [ 2 * u - 3 * v , u * v ] ; b ; [ u , v ]$$

$$A := [ \begin{matrix}2 & - 3 \\ v & u\end{matrix} ]$$

$$Q : mat ; jcb ( u , v ) ; u ; [ x \hat{} 2 * y , 5 * x + sin ( y ) ] ; v ; [ x , y ]$$

$$A := [ \begin{matrix}2 xy & {x}^{2} \\ 5 & cos y\end{matrix} ]$$

$$Q : mat ; det ( jcb ( a , b ) ) ; a ; [ u - 2 * v , 3 * u + v ; b ; [ u , v ]$$

$$A := 7$$

$$Q : mat ; det ( jcb ( a , b ) ) ; a ; [ 2 * u - 3 * v , u * v ] ; b ; [ u , v ]$$

$$A : Jacobian = 2 u + 3 v$$

$$Q : mat ; det ( jcb ( u , v ) ) ; u ; [ x \hat{} 2 * y , 5 * x + sin ( y ) ] ; v ; [ x , y ]$$

$$A := 2 xy cos y - 5 {x}^{2}$$

$$Q : mat ; det ( jcb ( x , y ) ) ; x ; [ r * cos ( t ) , r * sin ( t ) ] ; y ; [ r , t ]$$

$$A : Jacobian = r$$

$$Q : mat ; det ( jcb ( u , v ) ) ; u ; [ r * cos ( t ) , r * sin ( t ) , z ] ; v ; [ r , t , z ]$$

$$A : Jacobian = r$$

$$Q : mat ; det ( jcb ( u , v ) ) ; u ; [ \text{} r * sin ( s ) * cos ( t ) , r * sin ( s ) * sin ( t ) , r * cos ( s ) ] ; v ; [ r , s , t ]$$

$$A : Jacobian = {r}^{2} sin ( s )$$

$$Q : mat ; jcb ( x , y ) ; x ; [ r * cos ( t ) , r * sin ( t ) ] ; y ; [ r , t ]$$

$$A : Jacobian = [ \begin{matrix}cos t & - r sin t \\ sin t & r cos t\end{matrix} ]$$

$$Q : mat ; jcb ( u , v ) ; u ; [ r * cos ( t ) , r * sin ( t ) , z ] ; v ; [ r , t , z ]$$

$$A : Jacobian = [ \begin{matrix}cos t & - r sin t & 0 \\ sin t & r cos t & 0 \\ 0 & 0 & 1\end{matrix} ]$$

$$Q : mat ; jcb ( u , v ) ; u ; [ r * sin ( s ) * cos ( t ) , r * sin ( s ) * sin ( t ) , r * cos ( s ) ] ; v ; [ r , s , t ]$$

$$A : Jacobian = [ \begin{matrix}sin s cos t & r cos s cos t & - r sin s sin t \\ sin s sin t & r sin t cos s & r sin s cos t \\ cos s & - r sin s & 0\end{matrix} ]$$

VII. Special Matrices

The function “diag(a, b, c)” returns a diagonal matrix with diagonal entries a, b, and c, “eye(m)” returns an m×m identity matrix, “ones(m)” returns an m×m matrix with all ones, and “zeros(m) returns an m×m matrix with all zeros.

Use the function “diag” to verify some important properties for diagonal matrices. For example, the inverse, sum, difference and product of diagonal matrices are still diagonal, and “mat;A\hat{ }(−2);A;diag(a,b,c)” returns the inverse of A², which is

$${A}^{- 2} = diag \{ \frac{1}{{a}^{2}} , \frac{1}{{b}^{2}} , \frac{1}{{c}^{2}} ) .$$

VIII. Random Matrices

The function “rdm(m)” returns an m-square random matrix. In general, “rdm(m, n, type, seed, lower, upper)” returns an m×n random matrix with optional parameters “n, type, seed, lower, upper”. The types of matrices indicated from 0 to 6 are: 0—random matrix; 1—diagonal matrix; 2—upper triangular matrix; 3—lower triangular matrix; 4—symmetric triangular; 5—Jordan block. To generate an m×n random matrix with seed and integer entries, use “mat; rdm(m, n, 0, seed, lower, upper)”.
Examples (1) “mat;rdm(2)” returns a 2×2 random matrix, and “mat; rdm(3, 2, 0, 234, −4, 4)” returns a 3×2 matrix with integer entries within the interval [−4, 4] and a seed=234.
(2) “mat;rdm(4)” returns a 4×4 random matrix, “mat;rdm(3,2)” returns a 3×2 random matrix, “mat;rdm(3,3,2)” returns a 3×3 random upper triangular matrix, “mat; rdm(4, 4,4,100,−5,5)” returns a 4×4 random symmetric matrix with seed=100 and its entries are integers randomly selected from −5 to 5, and “mat;rdm(4,4,5,1.5)” returns a 4×4 Jordan block with eigenvalue equal to 1.5.

The function “rdm” can be used to verify some properties for symmetric and triangular matrices. The inverse, sum, difference and product of real symmetric matrices are still symmetric. In particular, the diagonal entries of the product of triangular matrices are the product of their corresponding diagonal entries, and the diagonal entries of the inverse of a triangular matrix are the reciprocal of its diagonal entries.

For example, “mat; ivs(rdm(3,3,2,100))”, “mat; A*B−B*A; A;rdm(3,3,2,100); B;rdm(3,3,2,200)”, and “mat; A\hat{ }2−2*A*B+B\hat{ }2; A;rdm(3,3,2,100); B;rdm(3,3,2,200)” show that the three resulting matrices are upper triangular.

$$Q : mat ; diag ( 1 , 2 , 3 )$$

$$A := [ \begin{matrix}1 & 0 & 0 \\ 0 & 2 & 0 \\ 0 & 0 & 3\end{matrix} ]$$

$$Q : mat ; ones ( 3 )$$

$$A := [ \begin{matrix}1 & 1 & 1 \\ 1 & 1 & 1 \\ 1 & 1 & 1\end{matrix} ]$$

$$Q : mat ; eye ( 3 )$$

$$A := [ \begin{matrix}1 & 0 & 0 \\ 0 & 1 & 0 \\ 0 & 0 & 1\end{matrix} ]$$

$$Q : mat ; A ; A ; rdm ( 2 , 3 , 0 , 345 , 0 , 9 )$$

$$A := [ \begin{matrix}4 & 0 & 2 \\ 6 & 1 & 3\end{matrix} ]$$

$$Q : mat ; rdm ( 3 , 3 , 4 , 20 )$$

$$A := [ \begin{matrix}- 6 & - 2 & 10 \\ - 2 & - 7 & 0 \\ 10 & 0 & 8\end{matrix} ]$$

$$Q : mat ; rdm ( 3 , 3 , 2 , 30 )$$

$$A := [ \begin{matrix}- 7 & - 1 & 9 \\ 0 & 9 & 10 \\ 0 & 0 & - 9\end{matrix} ]$$

IX. Addition, Subtraction, Multiplication, and Power

The operators +, −, * also apply to matrix addition, subtraction, scalar and matrix multiplication. For multiplying two matrices A and B, “A*B” and “B*A” calculate the products of AB and BA, respectively, provided they are defined. Enter “A**n” or “A\hat{ }n” for the power of a matrix A, where “A” must be a square matrix and “n” is a whole number exponent. For example, the “A+3*B” gets the sum of A+3B.

X. Transpose, Conjugate, and Conjugate Transpose

The function “tsp(A)” returns A^{T}, the transpose of A. For complex matrices, “tsp(A)” returns the conjugate transpose of A, and “cjg(A)” just returns the conjugate of A.

XI. Matrix Inverse

Both “ivs(A)” and “A\hat{ }(−1)” return the inverse of a square matrix A. If A is not square, “ivs(A)” returns the Moore-Penrose pseudoinverse, but “A\hat{ }(−1)” is not defined. Also note that matrix polynomials and whole number exponents only apply to square matrix. For example, the matrices B and C in “A*B**(−1)” (for AB⁻¹) and “3*A*B**3+4*C**(−2)” (for 3AB³+4C⁻²) must be square matrices.

XII. Matrix Polynomials

A matrix polynomial is a polynomial with square matrices as variables. Given an ordinary scalar-valued polynomial f(t)=a₀+a₁t+a₂t²+ . . . +aₙtⁿ, the matrix polynomial is f(A)=a₀I+a₁A+a₂A²+ . . . +aₙAⁿ. For example, “A\hat{ }2−3*A+2*eye(2)” calculates the matrix polynomial f(A)=A²−3A+2I₂.
Examples (1) There are several ways to obtain the dot product ax+by+cz of two real vectors, for instance, u=(a, b, c) and v=(x, y, z). Enter each vector as a column by “mat; tsp(u)*v; u;[a,b,c]; v;[x,y,z]”, enter each vector as a row by “mat; u*tsp(v); u;[(a,b,c)]; v;[(x,y,z)]”, or enter one as a row and the other as a column by “mat; u*v; u;[(a,b,c)]; v;[x,y,z]”.

(2) For complex matrices for example, “mat; tsp(v)*u; u;[1+I,2,3]; v; [4−3*I,5*I,6+I]” returns the inner product <u, v>, which is 19−6i, because tsp(v) gives the conjugate transpose of the 3×1 complex matrix v (column vector). The same result can be obtained by “mat; cjg(v)*u; u;[1+I,2,3]; v;[(4-3*1,5*1,6+I)]”, where v is a row vector.

Note that “mat; v*u; u;[1+I,2,3]; v;[(4−3*I,5*I,6+I)]”, “mat; u*v; u;[(1+I,2,3)]; v;[4−3*I,5*I,6+I]”, “mat; dot(u,v); u;[1+I,2,3]; v;[4−3*I,5*I,6+I]” return a different result 25+14i, because the product does not involve the conjugate of the second vector.

$$Q : mat ; A * B ; A ; [ ( 1 , 2 , 3 ) , ( 4 , 5 , 6 ) ] ; B ; [ 3 , - 1 , 2 ]$$

$$A := [ \begin{matrix}7 \\ 19\end{matrix} ]$$

$$Q : mat ; F * tsp ( G ) ; F ; [ ( 2 , - 1 , 3 ) , ( - 4 , 1 , 2 ) , ( 0 , - 1 , 5 ) ; G ; [ ( 1 , 0 , 1 ) , ( 2 , 3 , 1 ) ]$$

$$A := [ \begin{matrix}5 & 4 \\ - 2 & - 3 \\ 5 & 2\end{matrix} ]$$

$$Q : mat ; A * B ; A ; [ 1 , 2 , 3 ] ; B ; [ ( 4 , 5 , 6 ) ]$$

$$A := [ \begin{matrix}4 & 5 & 6 \\ 8 & 10 & 12 \\ 12 & 15 & 18\end{matrix} ]$$

$$Q : mat ; A * tsp ( B ) ; A ; [ 1 + I , 2 , 3 ] ; B ; [ 4 - 3 * I , 5 * I , 6 + I ]$$

$$A := 19 - 6 i$$

$$Q : mat ; a * A * b ; a ; [ ( x , y , z ) ] ; A ; [ ( 2 , - 1 , 0 ) , ( 1 , 2 , 1 ) , ( 0 , - 1 , 2 ) ] ; b ; [ x , y , z ]$$

$$A := [ 2 {x}^{2} + 2 {y}^{2} + 2 {z}^{2} ]$$

$$Q : mat ; P * D * inv ( P ) ; P ; [ ( 1 , 1 - 1 ) , ( 1 , 1 , 0 ) , ( 1 , 0 , 3 ) ] ; D ; diag ( 1 , 2 , 2 )$$

$$A := [ \begin{matrix}- 1 & 3 & - 1 \\ - 3 & 5 & - 1 \\ - 3 & 3 & 1\end{matrix} ]$$

$$Q : mat ; A * tsp ( A ) ; A ; [ ( 1 , 2 , 3 ) , ( 4 , 5 , 6 ) ]$$

$$A := [ \begin{matrix}14 & 32 \\ 32 & 77\end{matrix} ]$$

$$Q : mat ; tsp ( A ) * A ; A ; [ ( 1 , 2 , 3 ) , ( 4 , 5 , 6 ) ]$$

$$A := [ \begin{matrix}17 & 22 & 27 \\ 22 & 29 & 36 \\ 27 & 36 & 45\end{matrix} ]$$

$$Q : mat ; tsp ( A * B ) - tsp ( B ) * tsp ( A ) ; A ; [ 1 , 2 , 3 ] ; B ; [ ( 4 , 5 , 6 ) ]$$

$$A := [ \begin{matrix}0 & 0 & 0 \\ 0 & 0 & 0 \\ 0 & 0 & 0\end{matrix} ]$$

$$Q : mat ; C \hat{} 2 - 5 * C + 6 * B ; C ; [ ( 1 , - 2 ) , ( 1 , 4 ) ; B ; eye ( 2 )$$

$$A := [ \begin{matrix}0 & 0 \\ 0 & 0\end{matrix} ]$$

$$Q : mat ; 2 * A + 3 * A ** 2 ; A ; [ ( 2 , - 1 , 0 ) , ( 1 , 2 , 1 ) , ( 0 , - 1 , 2 ) ]$$

$$A := [ \begin{matrix}13 & - 14 & - 3 \\ 14 & 10 & 14 \\ - 3 & - 14 & 13\end{matrix} ]$$

$$Q : mat ; ( A - 2 * B ) * ( A \hat{} 2 - 4 * A + 6 * B ) ; A ; [ ( 2 , - 1 , 0 ) , ( 1 , 2 , 1 ) , ( 0 , - 1 , 2 ) ] ; B ; eye ( 3 )$$

$$A := [ \begin{matrix}0 & 0 & 0 \\ 0 & 0 & 0 \\ 0 & 0 & 0\end{matrix} ]$$

(2) Linear System of Equations

I. Solve a Linear System

Many problems in linear algebra reduce to finding the solutions of a system of linear equations. To solve a nonhomogeneous system of linear equations Ax=b, form the augmented matrix M=[A, b], and use the function “rref(M)” to obtain the solution, where “A” represents the coefficients matrix and “b” the constant vectors (column). The same results can be obtained by “rref(mrg(A,b))”, where “mrg(A,b)” merges the coefficient matrix A and the constants b by row. If the system has a unique solution, the solution is in the last column of “rref(M)” or “rref(mrg(A,b))”.

A nonhomogeneous system may have no solution, a unique solution, or infinitely many solutions. If rref(M) has a row “0=1”, the system has no solution; if rref(M) has a free variable, it has infinitely many solution; if rref(M) has no free variables, it has a unique solution.

Use “rref(A)” to reduce A to reduced echelon form and determine the solution of a homogeneous linear system Ax=0. The zero vector is not needed for finding the solution. Since a homogeneous linear system always has the zero solution, we only need to determine if the system has a nonzero solution. If rref(A) has a free variable, it has infinitely many nonzero solutions. If rref(A) has no free variables, it has the zero or trivial solution.
Examples (1) The function “mat; rref(mrg(M,b)); M;[(1,3,−2,0),(2,6,−5,−2),(0,0,5,10)]; b;[2,0,1]” shows that the linear system x+3y−2z=2, 2x+6y−5z−2w=0 and 5z+10w=1 has no solution because the last row of “rref(mrg(M,b))” is “0=1”.
(2) The function “mat; rref(mrg(A,b)); A;[(1,2,2), (2,5,7),(3,6,8)]; b;[1,0,−2]” shows that the system x+2y+2z=1, 2x+5y+7z=0, 3x+6y+8z=−2 has a unique solution x=−5, y=5.5, and z=2.5.
(3) The function “mat; rref(mrg(B,b)); B;[(1,2,−3),(3,0,1),(2,−2,4)]; b;[1,2,1]” shows the system x+2y−3z=1, 3x+z=2, 2x−2y+4z=1 has infinitely many solutions.
(4) The function “mat; rref(A); A;[(1,3,−2,0,2),(2,6,−5,−2,4),(1,3,1,6,2),(1,3,0,4,2)]” solves the homogeneous system x₁+3x₂−2x₃+2x₅=0, 2x₁+6x₂−5x₃−2x₄+4x₅=0, x₁+3x₂+x₃+6x₄+2x₅=0, x₁+3x₂+4x₄+2x₅=0. Observe that there are two pivot variables x₁, x₃ and three free variables x₂, x₄, x₅. Thus, the general solution is x₁=−3x₂−4x₄−2x₅, x₃=−2x₄, or x₁=−3r−4s−2t, x₂=r, x₃=−2s, x₄=s, x₅=tin parametric form for some arbitrary numbers r, s, t. Using the general solution, we can determine the dimension and a basis of the solution space.

$$Q : mat ; rref ( mrg ( A , b ) ) ; A ; [ ( 2 , 1 ) , ( 3 , - 2 ) ; b ; [ 5 , 4 ]$$

$$A : Solution = [ 2 , 1 ]$$

$$Q : mat ; rref ( mrg ( A , b ) ) ; A ; [ ( 1 , 2 , 2 ) , ( 2 , 5 , 7 ) , ( 3 , 6 , 8 ) ] ; b ; [ 1 , 0 , - 2 ]$$

$$A : Solution = [ \begin{matrix}- 5 & 5.5 & 2.5\end{matrix} ]$$

$$Q : mat ; rref ( mrg ( A , b ) ) ; A ; [ ( 2 , - 1 , 3 , 5 ) , ( 1 , 0 , - 1 , 2 ) , ( 1 , 1 , - 2 , 3 ) , ( 0 , 1 , 1 , 1 ) ] ; b ; [ 1 , 2 , 5 , - 3 ]$$

$$A := [ \begin{matrix}- 13 & - 6 & - 3 & 6\end{matrix} ]$$

$$Q : mat ; rref ( mrg ( A , b ) ) ; A ; [ \text{} ( 1 , 3 , - 2 , 0 ) , ( 2 , 6 , - 5 , - 2 ) , ( 0 , 0 , 5 , 10 ) ] ; b ; [ 2 , 0 , 1 ]$$

$$A : ( no solution )$$

$$rref = [ \begin{matrix}1 & 3 & 0 & 4 & 0 \\ 0 & 0 & 1 & 2 & 0 \\ 0 & 0 & 0 & 0 & 1\end{matrix} ]$$

$$Q : mat ; rref ( mrg ( A , b ) ) ; A ; [ ( 1 , 2 , - 3 ) , ( 3 , 0 , 1 ) , ( 2 , - 2 , 4 ) ] ; b ; ( 1 , 2 , 1 )$$

$$A : ( infinitely many solutions )$$

$$rref = [ \begin{matrix}1 & 0 & \frac{1}{3} & \frac{2}{3} \\ 0 & 1 & \frac{- 5}{3} & \frac{1}{6} \\ 0 & 0 & 0 & 1\end{matrix} ]$$

$$Q : mat ; rref ( A ) ; A ; [ ( 1 , 2 , 0 , 3 ) , ( 2 , - 4 , 3 , 0 ) , ( 1 , 2 , 3 , 1 ) ]$$

$$A : ( unique solution )$$

$$rref = [ \begin{matrix}1 & 0 & 0 & 2 \\ 0 & 1 & 0 & \frac{1}{2} \\ 0 & 0 & 1 & \frac{- 2}{3}\end{matrix} ]$$

II. Linear Combination

Given a vector u and a set of vectors S={v₁, v₂, . . . , vₙ} in Kⁿ, to determine if u can be expressed as a linear combination of the vectors in S is equivalent to solve the system Ax=u, where the columns of A are the given vectors in S. Reduce the matrix [A, u] to reduced row echelon form by “rref(mrg(A,u))”. If the system has a nonzero solution, u can be expressed as a linear combination of the vectors in S.
Examples (1) Express u=(2, 3, 5) as a linear combination of v₁=(2, 2, 3), v₂=(1, 0, 4), v₃=(3, 5, −1). Obtain the result rref(mrg(tsp(A),u)) from “mat; rref(mrg(tsp(A),u)); A;[(2,2,3), (1,0,4),(3,5,−1)];u;[2,3,5]”, and thus u=24 v₁−19 v₂−9 v₃, where the coefficients of the linear combination are in the last column of rref(mrg(tsp(A),u)).

(2) Express the vector (4, 7, −1) as a linear combination of the vectors (1, 1, 2), (3, −1, 4), (2, −2, 2). Obtain the result by “mat;ref(mrg(tsp(A),u));A;[(1,1,2),(3,−1,4),(2,−2,2)];u;[4,7,−1]”. The last row of the reduced row echelon form has “0=1”, so the system has no solution, and the vector cannot be expressed as a linear combination of the three vectors.

III. Determine Linear Independence

To show a set S={v₁, v₂, . . . , vₙ} is linearly independent, form a matrix A=[v₁, v₂, . . . , vₙ] whose columns are the given vectors in S, and solve the homogeneous system Ax=0 by “elf(A)”. If there is a zero row in elf(A), the set S is linearly dependent, because the system has a nonzero solution. If elf(A) does not have zero rows, the set is linearly independent, because the system only has the zero solution. If the rows (not columns) of A are the given vectors v₁, v₂, . . . , vₙ, use “elf(tsp(A))” to linear independence.

For example, determine if the vectors v₁=(2,−2,3,1), v₂=(1,−4,4,−3), v₃=(1,2,−1,4), v₄=(3,0,2,5) are linearly independent. Form a matrix A=[v₁, v₂, v₃, v₄] whose columns are the vectors and row reduce A to echelon form by “mat; elf(tsp(A)); A;[(2,−2,3,1),(1,−4,4,−3), (1,2,−1,4),(3,0,2,5)]”. Observe that the echelon matrix elf(tsp(A)) has two zero rows, and thus the four vectors are linearly dependent. In particularly, the columns C₁, C₂ are linearly independent because they correspond to a pivot, and the columns C₃, C₄ can be expressed as a linear combination of C₁, C₂. Accordingly, the vectors v₁, v₂ form a linearly independent subset, and v₃=av₁+b v₂, v₄=c v₁+d v₂ for some constants a, b, c, d.

IV. Determine a Vector in a Span

Given a spanning set S={v₁, v₂, . . . , vₙ}, to determine if a vector b is in span(S), solve the linear system Ax=b by “rref(mrg(A,b))”, where A is the matrix whose columns are the vectors in S. If the system has a nonzero solution, the vector b is in the span(S). If the system has no solution, the vector is not in the span. Accordingly, if “0=1” appears in the reduced row echelon matrix rref(mrg(A,b)), the vector b is not in the span. Otherwise, b is in span(S), or it can be expressed as a linear combination of the vectors in S.

V. Find Coordinate Vectors

Given a basis S={v₁, v₂, . . . , vₙ} of a vector space V, to obtain the coordinate vector of a vector b in V relative to S, solve the linear system Ax=b by “rref(mrg(A,b))”, where A is the matrix whose columns are the vectors in S.

For example, let u=(2,3,−1) and S={(1,1,0),(0,1,1),(2,1,−3)} be a basis of R³. To find the coordinates of u relative to the basis S, form a matrix A whose columns are the vectors in S, use “mat;ref(mrg(A,u));A;[(1,0,2),(0,1,1),(0,1,3)];u;[2,3,−1]”, and obtain that the coordinates [u]ₛ=(6,5,−2) correspond to the last column of rref(mrg(A,u)).

VI. Obtain Orthogonal Vectors

Given a set S={v₁, v₂, . . . , vₙ} of vectors, to obtain a vector x that is orthogonal to the vectors in S, solve the linear system Ax=0 for x by “rref(A)”, where A is the matrix whose rows are the vectors in the set.

VII. Obtain Eigenvectors

For a given n-square matrix A, to obtain the eigenvectors (or a basis of the eigenspace) belonging to an engenvalue λ, solve the linear system (A−λI)x=0 for x by “rref(A−λ*eye(n))”, where “eye(n)” gives an n×n identity matrix.

(3) Vector Space

I. Four Fundamental Subspaces

For an m×n matrix A, the function “nsp(A)” returns a list of vectors (row) that span the null space of A, and “nsp(tsp(A))” returns a list of vectors (row) that span the null space of A^{T} (left null space), where “nsp” (null space) is the function for finding a basis of the null space (or the kernel of a linear mapping with matrix A).

The function “rsp(A)” returns a list of vectors (row) that span the row space of A, and “rsp(tsp(A))” returns a list of vectors (row) that span the column space of A, where “rsp” (row space) is the function for finding the spanning set of the row space of A.

To determine if two sets of vectors span the same space, form two separate matrices whose rows are the given sets of vectors, reduce them to reduced row echelon form, and check if the nonzero rows of the reduced echelon matrices are the same.

For example, given two sets S₁={(1,−3,−2,5),(2,3,7,−1),(3,0,5,4)}, S₂={(1,6,9,−6),(4,−3,3,9),(0,9,11,−11)} in R⁴, determine if span(S₁)=span(S₂). Form a matrix A whose rows are the given vectors in S₁, and reduce A to reduced row echelon form. Form a matrix B whose rows are the given vectors in S₂, and reduce B to reduced row echelon form. Check the results with “mat;ref(A);A;[(1,−3,−2,5),(2,3,7,−1),(3,0,5,4)]” and “mat;ref(B);B;[(1,6,9,−6),(4,−3,3,9),(0,9,11,−11)]”. Observed that rref(A) and rref(B) have the same nonzero rows, and thus span(S₁)=span(S₂).

To determine the dimension and a basis of span(S₁) or span(S₂), use “mat;elf(A);A;[(1,−3,−2,5),(2,3,7,−1),(3,0,5,4)]” or “matrsp(A);A;[(1,−3,−2,5),(2,3,7,−1),(3,0,5,4)]”, and the results of elf(A) and rsp(A) shows the dimension of span(S₁) is 2 and a basis of span(S₁) is (1, −3, −2, 5) and (0, 9, 11, −11).

II. Dimension and Basis of a Vector Space

Given a set of vectors S={v₁, v₂, . . . , vₙ} that spans a subspace W, form a matrix A whose rows are the vectors in S, and evaluate an echelon matrix “elf(A)” to determine the dimension and a basis of W. The number of the nonzero rows in echelon form is the dimension of W, and the nonzero rows form a basis of W.

For instance, determine whether the vectors {(1,1,2,3), (3,−7,4,−1), (3,−2,5,4), (2,−8,2,−4)} in R⁴ form a basis of R⁴. Form a matrix A whose rows are the given vectors and reduce A to row echelon form by “mat;elf(A);A;[(1,1,2,3),(3,−7,4,−1),(3,−2,5,4),(2,−8,2,−4)]”. Observe that the result of elf(A) has two zero rows, and thus the vectors do not form a basis of R⁴. They span a subspace of dimension 2.

III. Kernel and Image of Linear or Matrix Mapping

Since an m×n matrix A can be viewed as a linear mapping, the image of the mapping is the column space of A by “rsp(tsp(A))”, and the kernel of the mapping is the null space of A by “nsp(A)”.
Examples (1) Find the dimension and a basis of the solution space W of the linear system x+y−z=0, 2x−3y+4z=0, 3x−2y+z=0. Form a matrix A whose rows are the coefficients of the system and reduce A to row echelon form by “mat;elf(A);A;[(1,1,−1),(2,−3,4),(3,−2,1)]”. Observe that the echelon matrix elf(A) has three nonzero rows and no free variables. Thus, the system has a zero (trivial) solution, the dimension of W is 0, and W has no basis. Verify the result by “matnsp(A);A;[(1,1,−1),(2,−3,4),(3,−2,1)]”, which gives an empty set.
(2) Find a linear mapping F: R³→R³ whose image is spanned by (2, 3, −2), (1, −4, 5), (0, 1, 1). Form a matrix B whose columns are the given vectors. The column space of B is the image of F. Thus, F(x, y, z)=B(x, y, z)^{T}=(2x+y, 3x−4y+z, −2x+5y+z) by “mat; tsp(B)*v; B;[(2,3,−2),(1,−4,5),(0,1,1)]; v;[x,y,z]”.
(3) Find a linear mapping F: R⁴— R³ whose kernel is spanned by (2,3,2,1) and (1,−2,2,3). Form a matrix A whose rows are the given vectors and obtain the null space of A by “matnsp(A);A;[(2,3,2,1),(1,−2,2,3)]”. Thus, F(x, y, z, w)=(10x−2y−7z, 11x−5y−7w).
(4) Let F: R³— R³ be a linear operator defined by F(x, y, z)=(2x−y+z, x−2y−z, x+y−2z) and f(t)=t 2−2t+3. Find f(F). Form a matrix whose rows are the coefficients of the components of F(x, y, z). Then f(F)=F(A), which can be obtained by “mat; A\hat{ }2−2*A+3*eye(3); A;[(2,−1,2),(1,−2,−1),(1,1,−2)]”, where “eye(3)” gives an 3×3 identity matrix. Thus, f(F)(x, y, z)=(4x+4y−3z, −3x+9y+8z, −z−7y+12z).

IV. Rank and Nullity of Linear or Matrix Mapping

If A is the matrix representation of a linear mapping T: V→U, the rank of the mapping is the dimension of the image of T (or the column space of A), and the nullity of the mapping is the dimension of the kernel of T (or the null space of A). Reduce the matrix A to echelon form by “elf(A)”. The number of pivots is the rank of T, the number of non-pivots is the nullity of T, and the sum of the rank and nullity is the dimension of V.

The rank of A can be obtained directly by the function rnk(A), which is the same as the number of nonzero rows in elf(A).

$$Q : mat ; rsp ( A ) ; A ; [ ( 2 , 4 , 2 ) , ( 1 , 2 , 1 ) , ( 0 , 1 , 0 ) ]$$

$$A := [ \begin{matrix}2 & 4 & 2 \\ 0 & 1 & 0\end{matrix} ]$$

$$Q : mat ; rsp ( tsp ( A ) ) ; A ; [ ( 2 , - 1 , 2 ) , ( 2 , 2 , 4 ) , ( 2 , - 1 , 2 ) ]$$

$$A := [ \begin{matrix}2 & 2 & 2 \\ 0 & 6 & 0\end{matrix} ]$$

$$Q : mat ; nsp ( tsp ( A ) ) ; A ; [ ( 2 , 3 , 1 ) , ( 3 , - 4 , 5 ) , ( 5 , - 1 , 6 ) ]$$

$$A := [ \begin{matrix}- 1 \\ - 1 \\ 1\end{matrix} ]$$

$$Q : mat ; rank ( rsp ( B ) ) ; B ; [ ( 1 , 2 , 1 , 2 ) , ( 0 , 3 , 1 , - 2 ) , ( - 1 , 1 , 0 , - 4 ) , ( 3 , 0 , 1 , - 1 ) ]$$

$$A := 3$$

$$Q : mat ; rank ( nsp ( B ) ) ; B ; [ ( 1 , 2 , 1 , 2 ) , ( 0 , 3 , 1 , - 2 ) , ( - 1 , 1 , 0 , - 4 ) ( 3 , 0 , 1 , - 1 ) ]$$

$$A := 1$$

$$Q : mat ; rank ( rsp ( tsp ( B ) ) ) ; B ; [ \text{} ( 1 , 2 , 1 , 2 ) , ( 0 , 3 , 1 , - 2 ) ( - 1 , 1 , 0 , - 4 ) , ( 3 , 0 , 1 , - 1 ) ]$$

$$A := 3$$

(4) Linear Mappings

I. Determine a Linear Mapping

A linear mapping can be determined by the values of a set of basis vectors. Use the “rref” function and a given basis to determine a linear mapping.

For example, let T: R³→R³ be a linear mapping and T(1,1,2)=(2,3,5), T(3,2,−2)=(1,0,3), and T(2,0,−5)=(3,−5,7). Note that the vectors in S={(1,1,2), (3,2,−2) and (2,0,−5)} form a basis of R³ and T is determined by the values of the basis vectors. To find the formula for T, let v=(a, b, c) in R³ and form a matrix A whose columns are the vectors in S. Observe that the formula is

$$T ( a , b , c ) = ( \frac{33 a - 37 b + 9 c}{7} , b + c , 11 a - 12 b + 3 c ) by$$

$$“ mat ; rref ( mrg ( tsp ( A ) , v ) ) ; A ; [ ( 1 , 1 , 2 ) , ( 3 , 2 , - 2 ) , ( 2 , 0 , - 5 ) ] ; v ;$$

$$[ a , b , c ] ” and “ mat ; tsp ( B ) * u ; B ; [ ( 2 , 3 , 5 ) , ( 1 , 0 , 3 ) , ( 3 , - 5 , 7 ) ] ; u ;$$

$$[ \text{} ( 10 * a - 11 * b + 4 * c ) / 7 , ( - 5 * a + 9 * b - 2 * c ) / 7 , ( 6 * a - 8 * b + c ) / 7 ] ” .$$

II. Determine Matrix Representation of Linear Operator

Given a linear operator T: V→V and a basis S={v₁, v₂, . . . , vₙ} of V, the matrix representation [T]ₛ of T relative to the basis S can be obtained by solving each linear system Ax=T(vᵢ) by “rref(mrg(A,b))”, where A is a matrix whose column are the basis vectors in S and b=T(vᵢ) is the image of each basis vector. The columns of [T]ₛ are the coordinate vectors of the images relative to S, or the solutions obtained in each linear system, which is the last column of rref(mrg(A,b)).

Instead of solving each linear system one at a time, use “rref(mrg(A,B*A))” to get the matrix representation of [T]ₛ, where B is the matrix representation of T relative to the usual basis, and the columns of B*A are the images of the basis vectors in S.

For example, let T: R³→R³ be a linear operator defined by T(x, y, z)=(2x−3y+z, x+2y, 4x−y+2z). Find the matrix representation of T relative to the basis S={(1,1,0), (2,1,−2), (1,0,3)} by “mat;ref(mrg(B,A*B));B;[(1,2,1),(1,1,0),(0,−2,3)]; A;[(2,−3,1),(1,2,0),(4,−1,2)]”, which returns the result [T]ₛ.

III. Matrix Representation and Matrix Mapping

Any m×n matrix A determines a linear mapping T: Kⁿ→K^{m} by T(u)=Au. If a matrix A is viewed as a linear mapping relative to the standard basis, the matrix representation of A relative to another basis S={v₁, v₂, . . . , vₙ} can be obtained by solving each linear system Px=Avᵢ by “rref(mrg(P,b))”, where the columns of P consist of the basis vectors in S, and the vector b=Avᵢ is the image for each basis vector vᵢ. The columns of the matrix representation [A]ₛ of A relative to S are the solutions of the linear systems. Rather than solving each linear system one at a time, observe that the right half of “rref(mrg(P,A*P))” is the matrix representation [A]ₛ of A relative to S, where the columns of “A*P” are the images of the basis vectors in S.

For example, if A=[(2,5,4),(0,1,2),(3,0,−4)] is considered as a linear operator on R³, and S={(1,4,2),(2,−3,7),(3,1,0)} is a basis of R³, the matrix representation [A]ₛ of A relative to S can be obtained by “mat;ref(B,A*B);A;[(2,5,4), (0,1,2),(3,0,−4)]B;[(1,4,2),(2,−3,7),(3,1,0)]”.

IV. Change of Basis Matrix

Given two different bases S₁={u₁, u₂, . . . uₙ} and S₂={v₁, v₂, . . . , vₙ} of a vector space V, P=[[v₁]_{S1}, . . . , [vₙ]_{S1}] is the change of basis matrix from S₁ to S₂, where the columns [vᵢ]_{S1} are the coordinate vectors of vᵢ relative to the basis S₁ for each i. Note that [vᵢ]_{S1} is also the solution of the linear system Ax=vᵢ and can be obtained by “rref(mrg(A,b)”, where the columns of matrix A are the vectors in S₁ and b=vᵢ is a column vector. If S₁ is the standard basis of V, then P=[v₁, v₂, . . . , vₙ], whose columns are the basis vectors in S₂.

The change of basis matrix from the bases S₂ to S₁ is Q=P⁻¹=[[u₁]_{S2}, . . . , [uₙ]_{S2}] Follow the above method to obtain the matrix Q, or find the inverse of P directly by “ivs(P)”.

For example, given that S={(1,2,3), (0,1,2), (1,1,0)} is a basis of R³, the change of basis matrix from the standard basis E to S is the matrix P whose columns are the given basis vectors in S, and the change of basis matrix from S to E is P⁻¹ obtained by “mat; ivs(P); P;[(1,2,3), (0,1,2),(1,1,0)]”. For any vector v=(a, b, c) in R³, the coordinate vector of v relative to the basis S is P⁻¹ v that can be obtained by “mat; ivs(P)*v; P;[(1,2,3),(0,1,2), (1,1,0)];v;[a,b,c]”, or by “mat;ref(mrg(P,v));P;[(1,2,3),(0,1,2),(1,1,0)];v;[a,b,c]”. The results from the two methods for [v]_{S} are the same.

(5) Inner Product Space

I. Inner Product on Rⁿ or Cⁿ

For vectors u and v in Cⁿ, “tsp(v)*u” returns the inner product of <u, v>, and “tsp(u)*v” gives the result of <v, u>. Note that the results of “tsp(v)*u” and “tsp(u)*v” are a single-entry matrix instead of a scalar.

The function “dot(u,v)” or “dot(v,u)” returns a scalar of the dot product <u, v> or <v, u>. For complex vectors and conjugate transpose, use “dot(tsp(u),v)” or “dot(u,tsp(v))” to compute inner product. For this reason, use the “dot” function to calculate inner product, so the scalar result can be combined with other matrix operations.

The function “nom(u)” calculates the 2-norm of a vector u, “nom(u,1)” returns the 1-norm, “nom(u, oo)” returns the infinity norm, and “nom(u−v)” returns the distance between the vectors u and v.
Examples (1) Calculate the inner product of (2,13,5,−4,11) and (3,1,24,17,7) by “mat; dot(u,v); u;[(2,13,5,−4,11)]; v;[3,1,24,17,7]”.
(2) Calculate the inner product <A, B> for matrices A=[(2,3,9),(12,25,−4)], B=[(10,7,−8),(21,8,−6)] by “mat;trace(tsp(B)*A);A;[(2,3,9),(12,25,−4)];B;[(10,7,−8),(21,8,−6)]”.
(3) Calculate <u, v>=68+7i for u=(1+2i, −i, 3−4i, 9) and v=(−3i,5+7i,9,6−5i) by “mat;dot(tsp(v),u);u;[1+2*I,−I,3−4*I,9];v;[−3*I,5+7*I,9,6−5*I]” and <v, u>=68−7i by “mat;dot(tsp(u),v);u;[1+2*I,−I,3−4*I,9];v;[−3*I,5+7*I,9,6−5*I]”.
(4) Given u=(2,13,5,1,−4). Get ∥u∥₁=25 by “mat;nom(u,1);u;[2,13,5,1,−4]”; get ∥u∥₂=\sqrt{215} by “mat;nom(u,2);u;[2,13,5,1,−4]”; get ∥u∥_{∞}=13 by “mat; nom(u,oo); u;[2,13,5,1,−4]”. Normalize the vector (1,2,2) by “mat;u/nom(u);u;[1,2,2]”, and normalize the vector (1, 1+i, 1−2i) by “mat;u/nom(u);u;[1,1+1,I−2*I]”.
(5) Given u=(2,5,3,7) and v=(1,6,−3,4). Get d₁(u−v)=∥u−v∥₁=11 by “mat;nom(u−v,1);u;[2,5,3,7];v;[1,6,−3,4]”; get d₂ (u−v)=∥u−v∥₂=\sqrt{47} by “mat; nom(u−v,2); u;[2,5,3,7];v;[1,6,−3,4]”; get d_{∞}(u−v)=∥u−v∥_{∞}=6 by “mat; nom(u−v,oo); u;[2,5,3,7]; v;[1,6,−3,4]”.
(6) Given u=(2i,2+i,3) and v=(1,2−3i,3+5i). Get d₁ (u−v)=∥u−v∥₁=11 by “mat; nom(u−v,1); u;[2*I,2+I,3];v;[1,2−3*I,3+5*I]”; get d₂ (u−v)=∥u−v∥2 by “mat;nom(u−v,2);u;[2*I,2+I,3];v;[1,2−3*I,3+5*I]”; get d_{∞}(u−v)=∥u−v∥_{∞}=6 by “mat;nom(u−v,oo);u;[2*I,2+I,3];v;[1,2−3*I,3+5*I]”.
(7) Find an orthogonal basis of u^{⊥} in C³ where u=(1,−2i,1+2i). A vector v=(x, y, z) in u⊥ satisfies the equation <v, u>=x−2iy+(1+zi)z=0. A basis of the solution space of this equation can be obtained by “mat;nsp(A);A;[(1,−2*I,1+2*I)]”. Orthogonalize this basis by “mat;grs(nsp(A));A;[(1,−2*I,1+2*I)]”.

II. Matrix Representation of Inner Product

Let V be a real inner product space with a basis S={v₁, v₂, . . . , vₙ}. Then the matrix A=[<vᵢ, vᵢ>] represents the inner product on V relative to the basis S. Clearly, A is symmetric. For any vectors u and v in V, <u, v>=[u]^{T} A[v]. Use “A*tsp(A)” and a basis to find the matrix representation of inner product.
Examples (1) Find a matrix representation of the usual inner product on R² relative to the basis {(1,2),(3,5)}. Form a matrix A whose columns are the given basis vectors. Then AA^{T} is the matrix representation by “mat;A*tsp(A);A;[(1,3),(2,5)]”.
(2) The matrix representation of the usual inner product on R³ relative to a basis {(1,2,2),(2,−5,4),(6,0,−3)} can be obtained by “mata*tsp(a);a;[(1,2,2),(2,−5,4),(6,0,−3)]”. Since the basis set is orthogonal, the resulting matrix is diagonal.
(3) The matrix representation of the usual inner product on C³ relative to a basis {(1,i,1+i),(i,1−i,2),(1+i30,−3i)} can be obtained by “mat;a*tsp(a);a;[(1,I,1+I),(I,1−I,2),(1+I,0,−3*I)]”. The resulting matrix is Hermitian.

III. Projection of u onto v

If v is nonzero, the component (Fourier coefficient) c of u along v can be calculated by “dot(u,v)/dot(v,v)”, and the projection of u along v is cv by “v*dot(u,v)/dot(v,v)”. Find cos(θ) by “dot(u,v)/(nom(u)*nom(v))”, where θ is an angle between u and v.
Examples (1) Find the projection of (1,2,3,4) along (2,2,−1,3) by “mat; v*dot(u,v)/dot(v,v); u;[1,2,3,4]; v;[2,2,−1,3]”.
(2) Find cos(θ) by “mat;dot(u,v)/(nom(u)*nom(v));u;[2,2,−1,3];v;[1,1,2,4]”, where θ is an angle between the vectors (2,2,−1,3) and (1,1,2,4).

IV. Projection of u Along a Subspace W

Suppose W=span{w₁, w₂, . . . , wₖ} is a subspace of Rⁿ. The projection of a vector v in Rⁿ in the subspace W equals A(A^{T}A)⁻¹ Av by “A*ivs(tsp(A)*A)*tsp(A)*v”, where the columns of A are the given vectors w₁, w₂, . . . , wₖ.
Examples (1) Find the projection of the vector (2,4,6,8) onto the subspace spanned by {(1,2,2,−1),(2,3,1,2)} by “mat;A*ivs(tsp(A)*A)*tsp(A)*v;v;[2,4,6,8];A;[(1,2),(2,3),(2,1),(−1,2)]”.
(2) Find the projection of the vector (1,2,−3,5) onto the subspace spanned by {(1,0,1,1),(0,1,1,−1)} by “mat;u*dot(v,u)/dot(u,u)+w*dot(v,w)/dot(w,w);v;[1,2,−3,5];u;[1,0,1,1];w;[0,1,1,−1]” or “mat; A*ivs(tsp(A)*A)*tsp(A)*v;v;[1,2,−3,5]; A;[(1,0),(0,1),(1,1),(1,−1)]”.

V. Gram-Schmidt Orthogonalization Process

Given a basis S={v₁, v₂, . . . , vₙ}, the function “grs(A)” returns a set of orthogonal vectors from S using the Gram-Schmidt process, where the rows of A consists the vectors in S and the rows of grs(A) are the orthogonal vectors corresponding to S. The function “grs(A,1)” normalizes the orthogonal vectors to form an orthonormal set.
Examples (1) Find an orthogonal basis of W I for W=span(2,2,4,3) by “mat;grs(nsp(A));A;[(2,2,4,3)]”. Note that “nsp(A)” returns a basis (row) of the null space of A with dimension 3, and the function grs(nsp(A)) orthogonalizes the basis by the Gram-Schmidt process.
(2) A subspace W of R⁴ is spanned by (1,2,2,1), (3,−2,1,−1), (1,0,2,1). Find an orthogonal basis of W by “mat;grs(A);A;[(1,2,2,1),(3,−2,1,−1),(1,0,2,1)]” and an orthonormal basis of W by “mat;grs(A,1);A;[(1,2,2,1),(3,−2,1,−1),(1,0,2,1)]”.
(3) Find an orthogonal matrix whose first row is (2,1,2). Extend the vector to form a basis of R³ by adding two vectors (1,2,1) and (1,1,4), and then use “mat; grs(A,1); A;[(2,1,2), (1,2,1),(1,1,4)]” to get an orthonormal set of the basis. It also returns an orthogonal matrix. Note that this matrix is not unique.
(4) Find an orthogonal basis of the subspace of C³ spanned by (i,2,3−4i) and (1,2−i,3+2i). “mat;grs(A);A;[(I,2,3−4*I),(1,2−I,3+2*I)]” gives an orthogonal basis of W, and “mat;grs(A);A;[(I,2,3−4*I),(1,2−I,3+2*I)]” yields an orthonormal basis of W.

VI. Verify Orthogonal Matrix

Check if the result of “ivs(P)*P” is an identity matrix. If it is an identity matrix, P is orthogonal. To verify if P is orthogonal is to verify that each row or column has unit length and that each pair of rows or columns is orthogonal.

For example, check if A=[(3,2,1),(1,−2,1),(4,−2,−8)] is an orthogonal matrix by “mat; A*tsp(A); A;[(3,2,1),(1,−2,1),(4,−2,−8)]”, which returns a diagonal matrix (but is not an identity matrix). Thus, A is not an orthogonal matrix. Observe that each pair of rows of A is orthogonal, and the Gram-Schmidt process returns the same rows of A by “mat;grs(A);A;[(3,2,1),(1,−2,1),(4,−2,−8)]”. Normalize each row by “mat; grs(A,1); A;[(3,2,1),(1,−2,1),(4,−2,−8)]”, and the resulting matrix grs(A,1) is orthogonal. Check it by “mat;grs(A,1)*tsp(grs(A,1));A;[(3,2,1),(1,−2,1),(4,−2,−8)]”, which yields an identity matrix.

$$Q : mat ; B * A ; A ; [ 1 , 2 , 1 + I ] ; B ; [ ( 2 - 3 * I , 2 * I , 3 + 2 * I ) ]$$

$$A := [ 3 + 6 i ]$$

$$Q : mat ; cjg ( B ) * A ; A ; [ 1 , 2 , 1 + I ] ; B ; [ ( 2 - 3 * I , 2 * I , 3 + 2 * I ) ]$$

$$A := [ 7 ]$$

$$Q : mat ; tsp ( a ) * b ; a ; [ 1 + I , 2 - 3 * I , 4 * I ] ; b ; [ 8 * I , - 4 * I , - 5 * I ]$$

$$A := [ 0 ]$$

$$Q : mat ; grs ( A ) ; A ; [ ( 1 , 2 , - 1 ) , ( 0 , 1 - , 0 ) , ( 1 , 1 , 1 ) ]$$

$$A := [ \begin{matrix}1 & 2 & - 1 \\ \frac{1}{3} & \frac{- 1}{3} & \frac{1}{3} \\ 1 & 0 & 1\end{matrix} ]$$

$$Q : mat ; grs ( A , 1 ) ; A ; [ ( 2 , 1 , 2 ) ( 0 , - 1 , 2 ) , ( 2 , 1 , 1 ) ]$$

$$A := \frac{1}{3} [ \begin{matrix}2 & 1 & 2 \\ - 1 & - 2 & 2 \\ 2 & - 2 & - 1\end{matrix} ]$$

$$Q : mat ; grs ( A , 1 ) * tsp ( grs ( A , 1 ) ) ; A ; [ ( 1 , 2 , 3 ) , ( 0 , 1 , 0 ) , ( 1 , 1 , 1 ) ]$$

$$A := [ \begin{matrix}1 & 0 & 0 \\ 0 & 1 & 0 \\ 0 & 0 & 1\end{matrix} ]$$

(6) Determinants and Definiteness

I. Determinant, Trace, Norm, Rank, Condition Number

For a given matrix A, the function “det(A)” returns its determinant, “trace(A)” returns the trace, “nom(A)” returns the Frobenius norm, “rnk(A)” returns the rank, and “cnd(A)” returns the condition number.

The “nom” function has an option for different types of norms. By default, “nom(A)” returns the 2-norm of A (Frobenius). The function “nom(A,1)” returns the 1-norm of A, “nom(A,2)” returns 2-norm, and “nom(A,oo)” returns infinity norm.

For example, find the volume of the parallelopiped determined by the three vectors (2,3,5), (1,4,0), (5,3,−6) by “mat;det(A);A;[(2,3,5),(1,4,0),(5,3,−6)]”. The volume is |det(A)|, which is 115.

| | | |
|---|---|---|
| Q: mat; norm(A); A; [(1, 1, 1), | Q: mat; rank(B); B; [(1, 2, 1, 2, 2), (0, 3, 1, −2, 2), | Q: mat; det(A); A; [(2, −1, 0), |
| (1, 2, 2), (1, 2, 3)] | (4, −2, 0, 1, 1), (3, 0, 1, −1, 4)] | (1, 2, 1), (0, −1, 2)] |
| A: =\sqrt{26} | A: =4 | A: =12 |
| Q: mat; cnd(A); A; [(1.85, 2.36), | Q: mat; norm(B, 1); B; [(1, 2, 1, 2), (0, 3, 1, −2), | Q: mat; norm(A, oo); A; [(2, −1, 0), |
| (−3.71, 5.4)] | (4, −2, 0, 1), (3, 0, 1, −1)] | (1, 2, 1), (0, −1, 2)] |
| A: =2.34264621295597 | A: =8 | A: =4 |

II. Minors, Cofactors and Adjugate Matrix

For the determinant (minor) of the submatrix after deleting the ith row and jth column of A, the function “mno(A, i, j)” returns the minor corresponding to the entry (i, j) of A, and “cfm(A)” returns the cofactor (signed minor) matrix of A (for all entries). The transpose of a cofactor matrix of A is the ajugate (classic adjoint) of A, that is “tsp(cfm(A))”. Note that minor corresponds to the entry (1, 1) of A is obtained by mno(A,0,0), rather than mno(A,1,1).

For example, given A=[(2,5,3),(3,6,7),(4,−1,2)], get the determinant by “mat; det(A); A;[(2,5,3), (3,6,7),(4,−1,2)]”; get the minor corresponding to the entry (2,3) by “mat; mno(A,1,2); A;[(2,5,3),(3,6,7),(4,−1,2)]”; get the cofactor matrix by “mat; cfm(A); A;[(2,5,3),(3,6,7),(4,−1,2)]”; verify the statement that the inverse of A equals the ratio of adjugate and determinant of A by “mat;ivs(A)−tsp(cfm(A))/det(A); A;[(2,5,3),(3,6,7),(4,−1,2)]”, which is a zero matrix.

$$Q : mat ; mno ( C , 1 , 2 ) ; C ; [ ( 1 , 6 , - 1 ) , ( 2 , 5 , 3 ) , ( 2 , 1 , 4 ) ]$$

$$A := - 11$$

$$Q : mat ; cfm ( A ) ; A ; [ ( 2 , - 1 , 0 ) , ( 1 , 2 , 1 ) , ( 0 , - 1 , 2 ) ]$$

$$A := [ \begin{matrix}5 & - 2 & - 1 \\ 2 & 4 & 2 \\ - 1 & - 24 & 5\end{matrix} ]$$

$$Q : mat ; tsp ( cfm ( A ) ) ; A ; [ ( 2 , 3 , 1 ) , ( 1 , 0 , - 4 ) , ( 5 , - 1 , 6 ) ]$$

$$A := [ \begin{matrix}- 4 & - 19 & - 12 \\ - 26 & 7 & 9 \\ - 1 & 17 & - 3\end{matrix} ]$$

III. True or False

The function “tof(A)” (True or False) tests whether a matrix is positive definite by default. Options can be added to the function as “tof(A, type)”, and the types indicated by integers from 0 to 6 are: 0—diagonalizable, 1—positive definite; 2—negative definite; 3—positive semidefinite; 4—negative semidefinite; 5—indefinite; 6—nilpotent.

For example, “mat;tof(A);A;[(1,2,−3),(2,4,6),(−3,6,5)]” returns False, but “mat;tof(A*A); A;[(1,2,−3),(2,4,6),(−3,6,5)]” returns True.

| | | |
|---|---|---|
| Q: mat; tof(A, 0); A; [(2, −1, 0), | Q: mat; tof(B); B; [(1, 2, 1, 2), (0, 3, 1, −2), | Q: mat; tof(A, 6); A; [(5, −3, 2), |
| (1, 2, 1), (0, −1, 2)] | (4, −2, 0, 1), (3, 0, 1, −1)] | (15, −9, 6), (10, −6, 4)] |
| A: =True | A: =False | A: =True |

(7) Eigenvalues and Eigenvectors

I. Characteristic Polynomials

The function “chp(A)” returns the characteristic polynomial p(λ)=det(λI−A) of a matrix A, which is the determinant of the matrix λI−A.
Examples (1) Find the characteristic polynomial by “mat; chp(A);A;[(3,2,2),(3,1,−4),(2,1,−3)]”. Verify that the characteristic polynomial of a block triangular matrix is the product of the characteristic polynomials of their diagonal blocks by the example “mat;chp(A); A;[(2,3,−5,8),(5,4,6,3),(0,0,9,7),(0,0,1,4)]” and “mat; chp(B)*chp(C); B;[(2,3),(5,4)]; C;[(9,7),(1,4)]”.

(2) Let f(t)=(t−2)(t 2−4t+6). The polynomial f(t) is the characteristic polynomial of M by “mat;chp(M);M;[(2,−1,0),(1,2,1),(0,−1,2)]”, and “mat; (M−2*eye(3))*(M\hat{ }2−4*M+6*eye(3)); M;[(2,−1,0),(1,2,1),(0,−1,2)]” returns a zero matrix, where “chp(A)” gives the characteristic polynomial of a matrix A.

II. Eigenvalues and Eigenvectors

The function “eig(A)” returns the eigenvalues and eigenvectors of a matrix A. The output of “eig(A)” (eigenvalues or eigenvectors) displays each eigenvalue, its algebraic multiplicity and the corresponding eigenvectors.

$$Q : mat ; chp ( A ) ; A ; [ ( 0 , 1 , 1 ) , ( 1 , 0 , 0 ) , ( 1 , 1 , 1 ) ]$$

$$A := λ ( λ - 2 ) ( λ + 1 )$$

$$Q : mat ; A * tsp ( A ) - tsp ( A ) * A ; A ; [ ( 2 , 3 * I ) , ( 3 * I , 2 ) ]$$

$$A := [ \begin{matrix}0 & 0 \\ 0 & 0\end{matrix} ]$$

$$Q : mat ; eig ( A ) ; A ; [ ( 0 , 1 , 1 ) , ( 1 , 0 , 0 ) , ( 1 , 1 , 1 ) ]$$

$$A := [ ( ( - 1 , 1 ) , [ [ \begin{matrix}- 1 \\ 1 \\ 0\end{matrix} ] ] ) , ( ( 0 , 1 ) [ [ \begin{matrix}0 \\ - 1 \\ 1\end{matrix} ] ] ) , ( ( 2 , 1 ) , [ [ \begin{matrix}\frac{2}{3} \\ \frac{1}{3} \\ 1\end{matrix} ] ] ) ]$$

$$Q : mat ; eig ( A ) ; A ; [ ( 1 , 2 ) , ( 2 , 1 ) ]$$

$$A := [ ( ( - 1 , 1 ) , [ [ \begin{matrix}- 1 \\ 1\end{matrix} ] ] ) , ( ( 3 , 1 ) , [ [ \begin{matrix}1 \\ 1\end{matrix} ] ] ) ]$$

III. Diagonalizing Real Symmetric Matrices

Many real matrices are not diagonalizable, but real symmetric matrices are diagonalizable. They have real eigenvalues, and eigenvectors belonging to distinct eigenvalues are orthogonal. Thus, for a real symmetric matrix, there exists an orthogonal matrix P such that D=P⁻¹ AP is diagonal. Use the function “ivs(dgl(A,0,1))*A*dgl(A,0,1)” to verify the relation D=P⁻¹ AP.

The procedure for orthogonally diagonalizing real symmetric matrices is similar to general diagonalizing procedure. However, when diagonalizing a real symmetric matrix, normalize the orthogonal eigenvectors, and orthogonalize eigenvectors that belong to the same eigenvalue (eigenvectors are automatically orthogonal for distinct eigenvalues) by the “grs” function.

IV. Quadratic Form

A quadratic form determines a symmetric matrix A. Use the function “dgl(A)” to find the orthogonal matrix P such that D=P^{T}AP.
Examples (1) “mat;dgl(A);A;[(−1,3,−1),(−3,5,−1),(−3,3,1)]” returns P and D such that the relation D=P^{T}AP.
(2) Given q(x, y, z)=(3x−2y−3z, −2x+2y−3z, −3x−2y+3z), q(x, y, z) determines a real symmetric matrix A. To diagonalize q(x, y, z) is to diagonalize A by “mat;dgl(A,1);A;[(3,−2,−3),(−2,2,−2),(−3,−2,3)]”, where dgl(A,1) returns orthonormal eigenvectors. Substitute

$$x = Py for x = \frac{2 \sqrt{3} r + \sqrt{6} s + \sqrt{2} t}{6} , y = \frac{2 \sqrt{3} r - 2 \sqrt{6} s}{6} ,$$

$$z = \frac{2 \sqrt{3} r + \sqrt{6} s + 3 \sqrt{2} t}{6} by “ mat ; dgl ( A , 1 , 1 ) * y ; A ; [ ( 3 , - 2 , - 3 ) ,$$

$$( - 2 , 2 , - 2 ) , ( - 3 , - 2 , 3 ) ] ; y ; [ r , s , t ] ” ( dgl ( A , 1 , 1 )$$

$$returns matrix P where y = ( r , s , t ) .$$

$$Obtain q ( y ) = - 2 r \hat{} 2 + 4 s \hat{} 2 + 6 t \hat{} 2 by “ mat ;$$

$$tsp ( dgl ( A , 1 , 1 ) * y ) * A * ( dgl ( A , 1 , 1 ) * y ) ; A [ ( 3 , - 2 , 3 ) ,$$

$$( - 2 , 2 , - 2 ) , ( - 3 , - 2 , 3 ) ] ; y ; [ r , s , t ] ” .$$

(3) Diagonalize a symmetric matrix A=[(7,3),(3,−1)]. The characteristic polynomial of A is p(λ)=(λ+2)(λ−8) by “mat;chp(A);A; [(7,3),(3,−1)]”, so the eigenvalues are λ=−2 and λ=8. Check it by “mat;eig(A);A; [(7,3),(3,−1)]”. Solve the system (A+2I)x=0 and obtain an eigenvector (1,−3). Solve (A−8I)x=0 and obtain an eigenvector (3, 1). The two eigenvectors are orthogonal. Normalize each eigenvector and form a matrix P whose columns are the normalized eigenvectors. Thus, A is similar to D=diag(−2,8)=P⁻¹ AP by “mat;ivs(P)*a*P;a;[(7,3),(3,−1)];P;[( 1/10\hat{ }(½), 3/10\hat{ }(½)),(− 3/10\hat{ }(½), 1/10\hat{ }(½))]”.
(4) Find a matrix A whose eigenvalues are 1, 2, 5 and the corresponding eigenvectors are (2,3,−1),(1,1,2),(3,0,4). Let D=diag(1,2,5) and P is the matrix whose columns are the eigenvectors. Then A=PDP⁻¹ by “mat;P*D*ivs(P);P;[(2,1,3),(3,1,0),(−1,2,4)];D;diag(1,2,3)”.
(5) Calculate the singular values of A=[(2,2),(0,1),(1,0)] by “mat; eig(tsp(A)*A); A;[(2,2),(0,1), (1,0)]”. The eigenvalues of A^{T} A are 9 and 1, and thus the singular values of A are 3 and 1.

(8) Diagonalization, Linear and Bilinear Forms

I. Adjoint Operators

Given an linear operator T on an inner product space V, to find its adjoint operator, first determine the matrix representation A of T relative to the usual basis, and then obtain the adjoint by “tsp(A)*v” for a vector v in V.
Examples (1) Find the adjoint of T on R³ defined by T(x, y, z)=(2x−3y+4z, 5x+y−2z, x−2y+z) by “mat;tsp(A)*u;A;[(2,−3,4),(5,1,−2),(1,−2,1)];u[x,y,z]”. Thus, T*(x, y, z)=(2x+5y+z, −3x+y−2z, 4x−2y+z).
(2) Find the adjoint of T on C³ defined by T(x, y, z)=(3x−iy+(2+3i)z, (2−5i)x+4y+7iz, 6x−(5+4i)y−9iz). It is T*(x, y, z)=(3x+(2+5i)y+6z, ix+6y−(5−4i)z, (2−3i)x−7iy+9iz) by “mat;tsp(A)*u;A;[(3,−I,2+3*I),(2−5*I,4,7*I),(6,−5−4*I,−9*I)];u[x,y,z]”.

II. Normal Matrices

To verify if a square matrix A is normal or if AA^{T}=A^{T} A, check if the result of “A*tsp(A)−tsp(A)*A” is a zero matrix. Hermitian (symmetric), skew-Hermitian (skew-symmetric), positive (definite) matrices are normal matrices that can be easily tested by the function “A*tsp(A)−tsp(A)*A”.

For example, determine if the matrix A=[(1,3),(2,4)] is normal by “mat; tsp(A)*A−A*tsp(A); A;[(1,3), (2,4)]” (not normal). Determine if A=[(3,5),(−5,3)] is normal by “mat; tsp(A)*A−A*tsp(A); A;[(3,5),(−5,3)]” (normal). Determine if the matrix A=[(1+2i,3i), (3,2+3i)] is normal by “mat;tsp(A)*A−A*tsp(A);A;[(1+2*I,3*I),(3,2+3*I)]” (normal).

III. Diagonalization

All normal matrices (or linear operators on a complex finite-dimensional inner product space) are diagonalizable. To determine if a matrix is diagonalizable, use “tof(A,0)” and it returns “True” or “False”, where the option 0 in the function “tof” is used to test whether a square matrix is diagonalizable.

The function “dgl(A)” returns two matrices P and D such that D=P⁻¹ AP and D is diagonal, where the function “dgl” (diagonalization) has two additional parameters dgl(A, normalize, PD). By default, the function returns two matrices P, D and the columns of P are not normalized (normalize=0). If normalize=1, the columns of P are normalized. The function only returns the matrix P if PD=1 and returns the matrix D if PD=2. Use “ivs(dgl(A,0,1))*A*dgl(A,0,1)” to verify the relation P⁻¹ AP=D.

IV. Jordan Canonical Form

A non-normal operator T on a complex finite-dimensional inner product space has a relatively simple form—Jordan canonical form, or T can be represented by an upper triangular matrix relative to an orthonormal basis of V.

If A is an arbitrary n-square complex matrix, there exists a unitary matrix P such that A is similar to a Jordan canonical form J=P*AP, where J is an upper triangular matrix with the eigenvalues of A on the diagonal. Note that if A has n linearly independent eigenvectors, A is diagonalizable, and J is diagonal.

The function “jcf(A)” returns matrices P and J (Jordan canonical form) for which J=P⁻¹ AP.
Examples (1) mat;jcf(A);A;[(2,3),(3,2)], (2) mat;jcf(A);A;[[6,5,−2,−3],[−3,−1,3,3],[2,1,−2,−3],[−1,1,5,5]], (3) mat;jcf(A);A;[(5,4,2,1),(0,1,−1,−1),(−1,−1,3,0),(1,1,−1,2)].

V. Linear Forms (Functionals), Dual Space, and Dual Basis

For a given basis of V, to find a basis of the dual space V*, form a matrix A whose columns are the given basis vectors, use “rref(mrg(A,eye(n))” to obtain the solutions at the same time for the n linear systems.
Examples (1) Given that {(2,−5), (1,3)} is a basis of R², find the dual basis {φ₁, φ₂}. By definition, we seek linear forms φ₁(x,y)=ax+by, φ₂(x,y)=cx+dy such that the images of the basis vector on φ₁, φ₂ are 1 and 0's. Solve the two linear system (one for φ₁ and the other for φ₂) by “mat;ref(mrg(tsp(A),eye(2)));A;[(2,−5),(1,3)]”, where the columns of A are the given basis vectors. Thus,

$${φ}_{1} ( x , y ) = \frac{1}{11} ( 3 x - y ) , {φ}_{2} ( x , y ) = \frac{1}{11} ( 5 x + 2 y )$$

form the dual basis.
(2) Find the basis {φ₁, φ₂, φ₃} that is dual to a basis {(2,−1,1),(1,3,2),(2,4,5)} of R³. Form a matrix A whose columns are the given basis vectors, and solve the three systems by “mat;ref(mrg(tsp(A),eye(3)));A;[(2,−1,1),(1,3,2),(2,4,5)]”. Thus,

$${φ}_{1} ( x , y , z ) = \frac{1}{13} ( 7 x - y - 2 z ) ,$$

$${φ}_{2} ( x , y , z ) = \frac{1}{13} ( 9 x + 8 y - 10 z ) , {φ}_{3} ( x , y , z ) = \frac{1}{13} ( - 5 x - 3 y + 7 z )$$

form the dual basis.

VI. Bilinear, Quadratic, and Hermitian Forms

To diagonalize a symmetric bilinear form f, find the matrix representation A of f in a basis, and then use the following procedure to determine the nonsingular matrix P. Form a matrix M=[A, I], apply a sequence of elementary row operations to M, and then apply the corresponding column operators to A (the left of M). This is equivalent to pre-multiplying A by Q and post-multiplying A by Q*, and thus D=QAQ* or D=P*AP, where P=Q*. Note that a nonsingular matrix Q is a product of elementary matrices.
Examples (1) Express the bilinear form f(u, v)=2x₁y₁−5x₁y₂+4x₁y₃+6x₂y₂+x₂y₁−7x₂y3+9x₃y₃ in matrix equation by “mat;tsp(u)*A*v;A;[(2,−5,4),(1,6,−7),(0,0,9)]; u;[a,b,c]; v;[r,s,t]”.
(2) One the other hand, if A=[(2,3,−5),(3,1,6),(−5,6,4)], the quadratic form u^{T}Au determined by the symmetric matrix A can be obtained by “mat;tsp(u)*A*u;A;[(2,3,−5),(3,1,6),(−5,6,4)];u;[x,y,z]”.
(3) Given a bilinear form f(u, v)=3x₁y₁+2x₁y₂−6x₁y₃+4x₂y₂−x₂y₁₊₈x₂y₃−7x₃y₁+5x₃y₃ on R³, to find the matrix representation B of f relative to the basis S={(2,1,1),(1,2,1),(−1,1,1)}, form a matrix M whose rows are the given basis, and form a matrix A whose rows are the coefficients of f. Obtain the matrix from “mat; M*A*tsp(M); M;[(2,1,1), (1,2,1),(−1,1,1)];A;[(3,2,−6),(−1,4,8),(−7,0,5)]”, which gives B=MAM^{T}.

Find the matrix representation C of fin the basis S′={(1,0,1),(1,1,1),(1,1,0)} by “mat;G*A*tsp(G);G;[(1,0,1),(1,1,1),(1,1,0)];A;[(3,2,−6), (−1,4,8),(−7,0,5)]”. Determine the change of basis matrix P from S to S′ by “mat;ref(mrg(tsp(M),tsp(G)));M;[(2,1,1),(1,2,1),(−1,1,1)];G;[(1,0,1),(1,1,1),(1,1,0)]”. Verify C=[(−5,−3,−2),(2,8,1),(4,10,8)]=P^{T}BP by “mat; tsp(P)*B*P;B;[(5,15,11),(13,29,31),(−1,12,32)];P;[(4/3,2/3,−1/3),(−1,0,1),(2/3,1/3,−2/31)]”.
(4) Find a nonsingular matrix P such that D=P^{T}AP is diagonal for a symmetric matrix A=[(2,−3,5),(−3,4,1),(5,1,6)]. Form a matrix M=[A, I] and reduce M to echelon form “mat;elf(mrg(A,eye(3)));A;[(2,−3,5),(−3,4,1),(5,1,6)]”. Observe that the matrix Q=[(1,0,0),(3,2,0),(−46,−34,−2)] is a lower triangular matrix at the right half of M, and P=Q^{T}. Verify D by “mat;P*A*tsp(P);P;[(1,0,0),(3,2,0),(−46,−34,−2)];A;[(2,−3,5),(−3,4,1),(5,1,6)]”. Note that the number of positive entries p=2, the number of negative entries n=1, rank(A)=3, and the signature of A is 1.
(5) Determine if q(x, y, z)=x²−2xy+4xz+5y²+6yz−6z² is positive definite by “mat;elf(mrg(A,eye(3)));A;[(1,−1,2),(−1,5,3),(2,3,−6)]” and “mat;P*A*tsp(P);A;[(1,−1,2),(−1,5,3),(2,3,−6)];P;[(1,0,0),(1,1,0),(−13,−5,4)]”, where the first result gets P, and the second finds D that has one negative diagonal entry. Thus, q is not positive definite. Also “mat;elf(tsp(elf(A)));A;[(1,−1,2),(−1,5,3),(2,3,−6)]” returns a diagonal matrix with one negative diagonal entry.
(6) Let q(x, y, z)=2x²−2xy+6xz−4yz+7y²−5z² be a quadratic form. Substitute x=2r−3s+t, y=r—s+2t, z=5r+2s+3t. Find q(r, s, t) in matrix equation by “mat; tsp(v)*tsp(P)*A*P*v; A;[(2,−1,3),(−1,7,−2),(3,−2,−5)]; P;[(2,−3,1),(1,−1,2),(5,2,3)]; v;[r,s,t]”, where A is the matrix representation of q in the standard basis, and P consists of the coefficients corresponding to the substitution.
(7) Given the substitution x=r+s−38t, y=2s+2t, z=26t, the matrix P for substitution is P=[(1,1,−38),(0,2,2),(0,0,26)], and “mat;tsp(v)*tsp(P)*A*P*v;A;[(2,−1,3),(−1,7,−2),(3,−2,−5)); P;[(1,1,−38),(0,2,2),(0,0,26)];v;r,s,t]” returns a quadratic form q(r, s, t) without cross product terms, because P^{T}AP is diagonal. Check the matrix Q by “mat; elf(mrg(A,eye(3))); A;[(2,−1,3),(−1,7,−2),(3,−2,−5)]” and P=Q^{T}.
(8) Find a nonsingular matrix P such that D=P*HP is diagonal, where H=[(2,6*I,−I),(−6*I,1,4+5*I),(I,4−5*I,5)] is Hermitian matrix. The matrix Q is at the right half of the result by “mat;elf(mrg(H,eye(3)));H;[(2,6*I,−I),(−6*I,1,4+5*I),(I,4−5*I,5)]”. Verify the relation D=QHQ*=P*HP by “mat;q*A*tsp(q);A;[(2,6*I,−I),(−6*I,1,4+5*I),(I,4−5*I,5)]; q;[(1,0,0), (6*I,2,0),(−60−50*I,−28+20*I,−68)]”.
(9) Find a nonsingular matrix such that D=P*HP is a diagonal for H=[(2,−3*I),(3*I,1)] by “mat;elf(mrg(H,eye(2)));H;[(2,−3*I),(3*I,1)]” and “mat;tsp(P)*H*P;H;[(2,−3*I),(3*I,1)]; P;[(1,3*I),(0,2)]”.
(10) Find a nonsingular linear substitution so that q(x, y, z)=x²+2xy−4xz+5y²+6yz+7z² is diagonal by “mat;elf(mrg(A,eye(3)));A;[(1,1,−2),(1,5,3),(−2,3,7)]”. Observe that P=[(1,−1,13),(0,1,−5),(0,0,4)]. Thus, substitute x=r−s+13t, y=s−5t, z=4t to obtain q(r, s, t)=r²+4s²−52t².

$$Q : mat ; dgl ( A ) ; A ; [ ( 4 , 1 , - 1 ) , ( 2 , 5 , - 2 ) , ( 1 , 1 , 2 ) ]$$

$$A : P = [ \begin{matrix}- 1 & 1 & 0 \\ 1 & 0 & 2 \\ 0 & 1 & 1\end{matrix} ]$$

$$D = [ \begin{matrix}3 & 0 & 0 \\ 0 & 3 & 0 \\ 0 & 0 & 5\end{matrix} ]$$

$$Q : mat ; dgl ( A , 1 ) ; A ; [ ( 4 , 1 , - 1 ) , ( 2 , 5 , - 2 ) , ( 1 , 1 , 2 ) ]$$

$$A := [ \begin{matrix}\frac{- \sqrt{2}}{2} & \frac{\sqrt{2}}{2} & \frac{\sqrt{6}}{6} \\ \frac{\sqrt{2}}{2} & 0 & \frac{\sqrt{6}}{3} \\ 0 & \frac{\sqrt{2}}{2} & \frac{\sqrt{6}}{3}\end{matrix} ]$$

$$D = [ \begin{matrix}3 & 0 & 0 \\ 0 & 3 & 0 \\ 0 & 0 & 5\end{matrix} ]$$

$$Q : mat ; inv ( dgl ( A , 0 , 1 ) ) * A * dgl ( A , 0 , 1 ) ; A [ ( 4 , 1 , - 1 ) , ( 2 , 5 , - 2 ) , ( 1 , 1 , 2 ) ]$$

$$A := [ \begin{matrix}3 & 0 & 0 \\ 0 & 3 & 0 \\ 0 & 0 & 5\end{matrix} ]$$

(9) Matrix Decomposition

Common matrix decomposition methods are implemented. They are (1) QR-decomposition (“qrd”), (2) LU-decomposition (“lud”), (3) singular value decomposition (“svd”), (4) Cholesky decomposition (“chl”), (5) rank decomposition (“rkd”), and (6) LDL-decomposition (“ldl”).

The function “qrd(A)” factors A as A=QR; “lud(A)” factors A as A=LU. In a similar fashion, the function “ldl(A)” returns matrices L and D for which A=LDL*; “cho(A)” returns matrix L for A=LL*; “svd(A)” returns matrices U, Σ and V for A=UΣV; “rkd(A)” returns matrices C and F for A=CF.
Examples (1) mat;qrd(A);A;[(2,5,14),(6,9,−11)], (2) mat;lud(A);A;[(4,3,2),(1,6,3),(2,5,1)], (3) mat;rkd(A);A;[(9,5,4),(3,5,1)], (4) mat;ldl(A);A;[(4,12,−16),(12,37,−43),(−16,−43,98)], (5) mat;cho(A);A;[(4,12,−16),(12,37,−43),(−16,−43,98)], (6) mat;svd(A);A;[(1,1,0),(1,0,1)].

$$Q : mat ; qrd ( A ) ; A ; [ ( 1 , 1 , 1 ) , ( 1 , 1 , 3 ) , ( 2 , 3 , 4 ) ]$$

$$A : Q = [ \begin{matrix}\frac{\sqrt{6}}{6} & - \frac{\sqrt{3}}{3} & - \frac{\sqrt{2}}{2} \\ \frac{\sqrt{6}}{6} & - \frac{\sqrt{3}}{3} & \frac{\sqrt{2}}{2} \\ \frac{\sqrt{6}}{3} & \frac{\sqrt{3}}{3} & 0\end{matrix} ]$$

$$R = [ \begin{matrix}\sqrt{6} & \frac{4 \sqrt{6}}{3} & 2 \sqrt{6} \\ 0 & \frac{\sqrt{3}}{3} & 0 \\ 0 & 0 & \sqrt{2}\end{matrix} ]$$

$$Q : mat ; lud ( A ) ; A ; [ ( 4 , 3 , 2 ) , ( 1 , 6 , 3 ) , ( 2 , 5 , 1 ) ]$$

$$A : L = [ \begin{matrix}1 & 0 & 0 \\ \frac{1}{4} & 1 & 0 \\ \frac{1}{2} & \frac{2}{3} & 1\end{matrix} ]$$

$$U = [ \begin{matrix}4 & 3 & 2 \\ 0 & \frac{21}{4} & \frac{5}{2} \\ 0 & 0 & - \frac{5}{3}\end{matrix} ]$$

$$Q : mat ; ldl ( A ) ; A ; ( ( 25 , 15 , - 5 ) , ( 15 , 18 , 0 ) , ( - 5 , 0 , 11 ) )$$

$$A : L = [ \begin{matrix}1 & 0 & 0 \\ \frac{3}{5} & 1 & 0 \\ - \frac{1}{5} & \frac{1}{3} & 1\end{matrix} ]$$

$$D = [ \begin{matrix}25 & 0 & 0 \\ 0 & 9 & 0 \\ 0 & 0 & 9\end{matrix} ]$$

$$Q : mat ; cho ( A ) ; A ; [ ( 25 , 15 , - 5 ) , ( 15 , 18 , 0 ) , ( - 5 , 0 , 11 ) ]$$

$$A : L = [ \begin{matrix}5 & 0 & 0 \\ 3 & 3 & 0 \\ - 1 & 1 & 3\end{matrix} ]$$

$$Q : mat ; svd ( A ) ; A ; [ ( 1 , 2 ) , ( 2 , 1 ) ]$$

$$A : U = [ \begin{matrix}\frac{\sqrt{2}}{2} & \frac{\sqrt{2}}{2} \\ - \frac{\sqrt{2}}{2} & \frac{\sqrt{2}}{2}\end{matrix} ]$$

$$\sum = [ \begin{matrix}1 & 0 \\ 0 & 3\end{matrix} ]$$

$$V = [ \begin{matrix}- \frac{\sqrt{2}}{2} & \frac{\sqrt{2}}{2} \\ \frac{\sqrt{2}}{2} & \frac{\sqrt{2}}{2}\end{matrix} ]$$

$$Q : mat ; rkd ( A ) ; A ; [ ( 1 , 1 , 1 ) , ( 1 , 2 , 2 ) ]$$

$$A : C = [ \begin{matrix}1 & 1 \\ 1 & 2\end{matrix} ]$$

$$F = [ \begin{matrix}1 & 0 & 0 \\ 0 & 1 & 1\end{matrix} ]$$

What is claimed is:

1. A non-programming platform consisting of modules (functions) for matrix and vector operations, and each module carrying out a class of distinct operations in linear algebra, which include (1) matrices and vector operations and manipulations (addition, subtraction, multiplication, inverse, matrix polynomials, merging matrices, transpose, conjugate of complex matrices, rotation matrices, Jacobian matrices, special matrices, and random matrices); (2) finding determinants, traces, minors, cofactor matrices, norms, ranks, and condition numbers; (3) determining if a matrix is diagonalizable and nilpotent, and determining definiteness (positive definite, positive semidefinite, negative definite, negative semidefinite, indefinite); (4) solving linear systems by reducing a matrix to echelon form or reduced row echelon form, determining linear independence and linear combinations, determining a vector in a span, and finding coordinate vectors relative to various bases; (6) determining the dimension and a basis for the four fundamental subspaces of a matrix or linear mapping; (7) determining a linear mapping, the matrix representation of a linear mapping, and the change of basis matrix from one basis to another; (8) computing inner product, distance and angle between two vectors, matrix representation of inner product, determining orthogonal projection in an inner product space, and verifying orthogonal and normal matrices; (9) computing eigenvalues and eigenvectors, singular values, characteristic polynomials, and using Gram-Schimdt process to generate an orthogonal or orthonormal set of vectors; (10) diagonalizing a matrix or linear operator (real symmetric matrices and quadratic forms) using eigenvalues and eigenvectors; (11) matrix decomposition and Jordan canonic forms; (12) computing adjoint operators, determining linear forms and dual bases, determining bilinear forms in matrix equations, matrix representation, change of basis matrix for bilinear forms, and diagonalizing symmetric and Hermitian matrices, normal matrices, symmetric bilinear forms, quadratic forms, and Hermitian forms; wherein applying each module for its associated operations requires one short line of self-explaining input that consists of necessary elements such as module names (e.g., “ref”, “eig”, “mrg”, “det”), expressions and functions, variables, numbers, keywords, and other related parameters; wherein users can access and interact with these modules in many different ways: (I) using a typical standalone personal computer (workstation or server) that has these modules installed, and has Windows 10, Unix or Linux, or Mac OS with an Intel or other similar processor of 2.50 GHz frequency (or greater) and 64 bit 4 GB (or greater) RAM; (II) through an online web application (already created) with a computer, cell phone, smart phone, tablet or ipad, or other similar devices that have an access to the Internet.

2. The platform for claim 1 wherein each module or function can be applied in the following formats, depending on the needs and appropriateness of combining and composing different modules and math functions: (A) standalone; (B) linear combination; (C) combining with other modules and math functions; (D) composing with other modules and math functions; (E) combining and composing with other modules and math functions.
